(19) United States
(12) Patent Application Publication
(10) Pub. No.: US 2006/0170389 A1
(43) Pub. Date: Aug. 3, 2006

(54) Medium voltage switched reluctance motors used in traction applications

(75) Inventor: Rodwan T. Adra, Peoria, IL (US)

Correspondence Address: CATERPILLAR/FINNEGAN, HENDERSON, L.L.P., 901 New York Avenue, WASHINGTON, DC, 20001-4413, US

(73) Assignee: Caterpillar Inc

(21) Appl. No.: 11/045,317

(22) Filed: Jan. 31, 2005

(51) Int. Cl. H02P 1/46

(52) U.S. Cl. 318/701

(57) ABSTRACT

A work machine having an electric propulsion system includes at least one traction device and one or more medium voltage switched reluctance traction motors operating at a voltage level between 1,000 volts and 6,000 volts. The motors provide driving power to the at least one traction device.

### TECHNICAL FIELD

This disclosure relates generally to electric traction motors and, more particularly, to medium voltage switched reluctance traction motors.

### BACKGROUND

Modern work machines or vehicles may be powered by electrical propulsion systems. The electrical propulsion systems often include electric drive traction systems that provide driving force to traction devices of the work machines or vehicles operated on high power density batteries. Electric drive traction systems may often use conventional medium voltage induction motors (e.g., motors designed to operate in a range of about 1000 to about 6000 volts).

Conventional medium voltage induction motors typically include electrical coils inside the motor formed by connecting together a series of formed type coils. A formed type coil can be made using a square magnet wire that is first formed on a mandrel and then coated with insulation tape. The insulation tape may be applied by wrapping the entire length of formed magnet wire with overlapping wraps of the insulation tape. The series of wrapped coils may then be inserted into the slots of a stator of the medium voltage induction motor. The series of wrapped coils may be electrically connected together by end turns. The end turns of the motor are electrical wires connecting the wrapped coils between stator slots on both ends of the motor.

In this type of induction motor, the end turns do not contribute to torque generation. These end turn wires, however, can increase the total length of coils and overall cost of the medium voltage induction motor. For example, wound type coils of the motor may include eight inches or more of end turns on each end of the motor for a total of sixteen inches or more of end turns. Because of the complexity of the manufacturing processes and the extra end turns needed in medium voltage induction motors, the cost of the medium voltage induction motor may be prohibitive.

In addition, these extra end turns in the induction motor may cause additional losses within the motor due to increased coil resistance. These additional losses may result in lower efficiency and therefore may generate more heat within the motor. Larger cooling systems may then be required to remove the additional heat.

Because of the structural arrangement of an induction motor, an impractically large motor volume may be required to achieve a desired output power or torque level at a medium voltage level. Particularly, a medium voltage electric drive traction system in a vehicle may utilize one traction motor at each traction device. Multiple traction motors may then be used. However, width of the vehicle and total mounting space on the vehicle may be limited. Thus, the volume of space available for the traction motors may be limited, which can render the use of medium voltage induction motors impractical.

Medium voltage induction motors may present other challenges as well. For example, the speed of the motor may be limited by centrifugal forces on the rotor cage. These centrifugal forces may increase when the speed of the motor or the diameter of the motor is increased. Further, the speed limitation on the motor may also limit the final gear ratio that can be used between the motor and the ground. In order to overcome this limitation, a motor with an increased torque capacity may be required. Such a solution, however, may further increase the volume of the motor.

As an alternative to induction motors, switched reluctance motors have been proposed for use with electric vehicles. PCT Patent Application Publication No. WO 2004/055958 to Xiaolan A I et al. describes an integrated electric motor and traction drive system. However, such switched reluctance traction motors typically operate at low voltage levels (e.g., below 1,000 volts) and, therefore, may be incapable of providing a desired level of power output at a medium voltage level.

Methods and systems consistent with certain features of the disclosed systems are directed to solving one or more of the problems set forth above.

### SUMMARY OF THE INVENTION

One aspect of the present disclosure includes a work machine having an electric propulsion system. The work machine may include at least one traction device and one or more medium voltage switched reluctance traction motors operating at a voltage level between 1,000 volts and 6,000 volts to provide driving power to the at least one traction device.

Another aspect of the present disclosure includes a medium voltage switched reluctance traction motor for use on a work machine. The medium voltage switched reluctance traction motor may include a stator with a plurality of salient poles and 12 to 18 electrical coils wound on the plurality of salient poles of the stator. The medium voltage switched reluctance traction motor may also include a rotor with a plurality of poles.

Another aspect of the present disclosure includes a method of driving a work machine. The method may include providing, on the work machine, one or more medium voltage switched reluctance traction motors operating at a voltage level between 1,000 volts and 6,000 volts. The method may also include providing a power source configured to supply electrical power to the one or more medium voltage switched reluctance traction motors. The method may further include providing at least one traction device configured to move under influence of power from the one or more medium voltage switched reluctance motors.

### BRIEF DESCRIPTION OF THE DRAWINGS

The accompanying drawings, which are incorporated in and constitute a part of this specification, illustrate several embodiments and together with the description, serve to explain the principles of the disclosed embodiments. In the drawings:

FIG. 1 provides a functional block diagram of a work machine incorporating certain disclosed embodiments; and

FIG. 2 illustrates an exemplary medium voltage switched reluctance traction motor consistent with certain disclosed embodiments.

### DETAILED DESCRIPTION

Reference will now be made in detail to exemplary embodiments, which are illustrated in the accompanying drawings. Wherever possible, the same reference numbers will be used throughout the drawings to refer to the same or like parts.

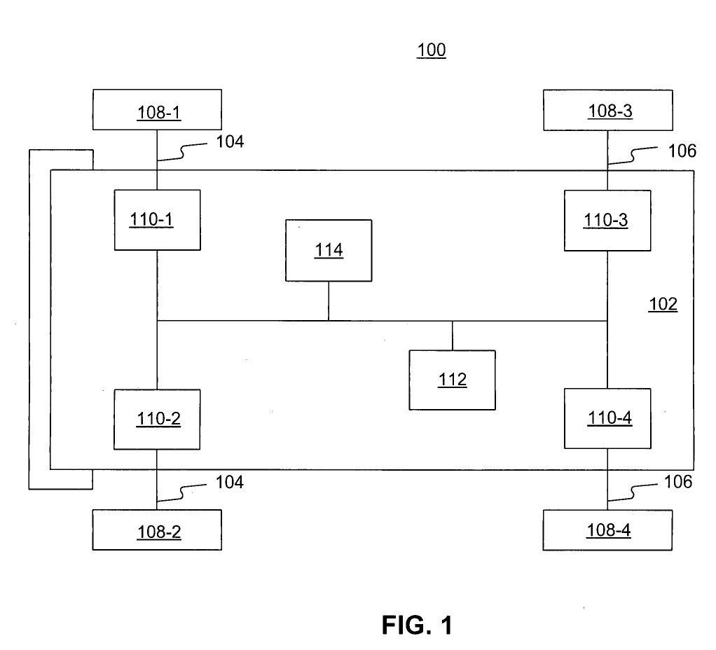

FIG. 1 illustrates an exemplary work machine 100 incorporating the disclosed embodiments. Work machine 100 may refer to any type of mobile machine that performs some type of operation associated with a particular industry, such as mining, construction, farming, transportation, etc. and operates between or within work environments (e.g., construction site, mine site, power plants, on-highway applications, etc.). Work machine 100 may also refer to any type of automobile or commercial vehicle. Non-limiting examples of mobile machines include on-highway vehicles, commercial machines, such as trucks, cranes, earth moving vehicles, mining vehicles, backhoes, material handling equipment, farming equipment, marine vessels, aircraft, and any type of movable machine that operates in a work environment.

As shown in FIG. 1, work machine 100 may include a chassis 102, a front axle 104, a rear axle 106, traction devices 108-1 to 108-4 (e.g., wheels, tracks, etc.), medium voltage switched reluctance traction motors 110-1 to 110-4, a power source 112, and a controller 114. Power source 112 may be any type of power source that provides electrical power to medium voltage switched reluctance traction motors 110-1 to 110-4 and/or other components (not shown) on work machine 100. Power source 112 may use a conventional internal combustion engine (e.g., a diesel or gas-powered engine) coupled with a generator to supply electrical power to traction motors 110-1 to 110-4. Alternatively, power source 112 may be a fuel cell generator configured to directly supply electrical power to traction motors 110-1 to 110-4. Power source 112 may also include a hybrid system including two or more different types of devices for converting an energy supply to electrical energy or for directly supplying electrical energy.

Medium voltage switched reluctance traction motors 110-1 to 110-4 may be mounted on chassis 102 to provide driving force to traction devices 108-1 to 108-4, respectively. Traction devices 108-1 and 108-2 may be supported by front axle 104 and driven by traction motors 110-1 and 110-2, respectively. Traction devices 108-3 and 108-4 may be supported by rear axle 106 and driven by traction motors 110-3 and 110-4, respectively. Medium voltage switched reluctance traction motors 110-1 to 110-4 may be mounted by any appropriate means. For example, medium voltage switched reluctance traction motors 110-1 and 110-2 may be mounted back to back in the direction of front axle 104, and medium voltage switched reluctance traction motors 110-3 and 110-4 may be mounted back to back in the direction of rear axle 106. Other types of mounting means, however, may also be used.

Medium voltage may refer to a voltage level between 1,000 and 6,000 volts, at which medium voltage switched reluctance traction motors 110-1 to 110-4 may operate. Medium voltage switched reluctance traction motors 110-1 to 110-4 may be specially designed to operate at the medium voltage levels. For example, the volume of medium voltage switched reluctance traction motors 110-1 to 110-4 may be configured to be compact to fit in medium voltage traction applications; internal wirings, electrical coils, and/or control circuitries of medium voltage switched reluctance traction motors 110-1 to 110-4 may also be designed for medium voltage traction applications. Operating at these voltage levels, medium voltage switched reluctance traction motor may generate a desired amount of horsepower to drive traction devices 108-1 to 108-4. In certain embodiments, an individual medium voltage switched reluctance traction motor may generate 400 horsepower or more. In certain other embodiments, an individual medium voltage switched reluctance traction motor may generate 600 horsepower or more.

Controller 114 may control operations of power source 112 and medium voltage switched reluctance traction motors 110-1 to 110-4. Controller 114 may be any appropriate type of control system used to control medium voltage switched reluctance traction motors, and/or operations, such as power source 112. Although not shown in FIG. 1, controller 114 may include any appropriate type of sensors, microcontrollers or microprocessors, digital signal processors, memory modules, or other electronic components. Controller 114 may also provide control functionalities to other components (not shown) of work machine 100.

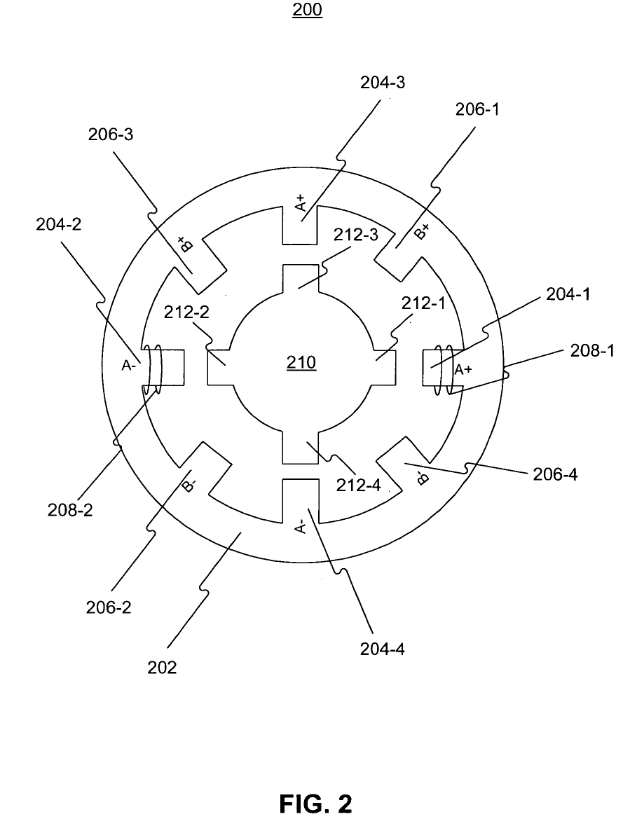

In operation, medium voltage switched reluctance traction motors 110-1 to 110-4 may be supplied electrical power in the form of direct current (DC) from power source 112. Structural details of medium voltage switched reluctance traction motors 110-1 to 110-4 are illustrated in FIG. 2.

FIG. 2 shows an exemplary medium voltage switched reluctance traction motor 200. Medium voltage switched reluctance traction motor 200 may be representative of any of medium voltage switched reluctance traction motors 110-1 to 110-4. As shown in FIG. 2, medium voltage switched reluctance traction motor 200 may include a stator 202, a rotor 210, and stator coils (e.g., electrical coils 208-1 and 208-2). Medium voltage switched reluctance traction motor 200 may also include a power converter (not shown) to supply a voltage to the motor at a voltage level between 1,000 and 6,000 volts. Although FIG. 2 illustrates an 8/4 two-phase medium voltage switched reluctance traction motor, those skilled in the art will recognize that other topologies may also be used.

Stator 202 may include a plurality of salient stator poles configured in groups of stator pole sets. A stator pole set may include two or more stator poles corresponding to the number of phases of medium voltage switched reluctance traction motor 200. For example, medium voltage switched reluctance traction motor 200 may be a 2-phase switched reluctance traction motor, and stator 202 may include a total of 8 stator poles grouped into two phase sets such that stator poles 204-1 to 204-4 may be grouped as one phase set and stator poles 206-1 to 206-4 may be grouped as the other phase set. Each stator pole of stator poles 204-1 to 204-4 and 206-1 to 206-4 may be wound by electrical coils. For example, stator poles 204-1 and 204-2 may be wound by electrical coils 208-1 and 208-2, respectively. Other stator poles (e.g., stator poles 204-3, 204-4, and 206-1 to 206-4) may also be wound by electrical coils (not shown).

The total number of electrical coils may be determined based on the total number of stator poles. For example, each stator pole may be wound by one electrical coil. In certain embodiments, medium voltage switched reluctance traction motor 200 may include a total of 12 to 18 stator poles and a total of 12 to 18 electrical coils. The length of end turn wires used to connect these 12 to 18 electrical coils may then be approximately 3 inches per end, which may result in a total 6 inches of end turns for medium voltage switched reluctance traction motor 200. Other numbers of electrical coils and/or stator poles, however, may also be included.

Rotor 210 may include a plurality of rotor poles. For example, rotor 210 may include a total of four rotor poles 212-1 to 212-4. It is understood that the number of stator poles and rotor poles is exemplary only and not intended to be limiting. Any number of stator poles and the associated rotor poles may be used.

In operation, a DC current may be introduced to pass through the electrical coils on stator poles by power source 112. For example, a DC current may be introduced to electrical coils 208-1 and 208-2. Associated with electrical coils 208-1 and 208-2, stator poles 204-1 and 204-2 may be excited to generate a magnetic flux. A torque may then be generated by a tendency of rotor 210 to align with excited stator poles 204-1 and 204-2. The direction of the torque generated may be a function of the position of rotor poles 212-1 to 212-4 with respect to the position of the stator poles 204-1 and 204-2. The direction of the torque may be dependent on the position of rotor 210 (e.g., rotor poles 212-1 to 212-4) relative to stator 202, but independent of the direction of the DC current flowing through electrical coils 208-1 and 208-2. Other stator poles may be subsequently excited by the DC current to cause rotor 210 to continuously rotate under the tendency to align with different excited stator poles. Continuous torque may then be generated by synchronizing the excitation of the stator poles with the instantaneous position of rotor poles 212-1 to 212-4 in respect to the application of the DC current to one of the phase sets. The synchronization and other operations may be controlled and/or provided by controller 114. The generated torque may then be provided to drive traction devices 108-1 to 108-4.

### INDUSTRIAL APPLICABILITY

The disclosed medium voltage switched reluctance motors may include salient poles and coils. The salient pole and coil structures may be easier and less costly to construct, especially as compared to traditional induction motors. The disclosed medium voltage switched reluctance motors may also include fewer electrical coils, which may further reduce the cost of the motors.

The disclosed medium voltage switched reluctance motors may include shorter end turns. The reduced end turn length may be used to produce more torque or to reduce the volume of the motors. For example, in traction applications, the volume of traction motors may be limited due to limited vehicle width. Thus, the total coil length of the traction motors may be limited. The disclosed medium voltage switched reluctance motors may achieve more torque in the total coil length available on traction motors due to volume limitations.

The disclosed medium voltage switched reluctance motors may exhibit higher efficiencies due to decreased coil losses from reduced end coil lengths and reduced rotor losses by eliminating current carrying conductors within the rotors. This higher efficiency may reduce the amount of heat generated within the motors and may further result in a combination of smaller motor size and smaller cooling systems in traction applications. In addition, these higher efficiencies may also result in a combination of lower fuel consumption and/or increased machine performance as compared with conventional induction motor systems.

When used in medium voltage traction applications at a voltage level between 1,000 and 6,000 volts, the disclosed medium voltage switched reluctance motors may provide reduced motor volume and increased horsepower that may be unavailable from conventional induction motors or general switched reluctance motors. Additionally, the disclosed medium voltage switched reluctance motors may also allow simple and robust rotor construction. Simple and robust rotor construction may eliminate the speed limitation that most induction motors may have. Increased speed capability may allow an increase in the final gear ratio of the final reduction sets and further reduce the volume of the motors. This reduction in motor volume may be resulted from the reduced amount of torque required because of the increased gear ratio.

The above disclosed benefits and advantages of medium voltage switched reluctance traction motors may be used by any traction motor or electric drive vehicle manufacturer to reduce cost and to increase performance and reliability. Other embodiments, features, aspects, and principles of the disclosed exemplary systems will be apparent to those skilled in the art and may be implemented in various environments.

1. A work machine having an electric propulsion system, comprising:
at least one traction device; and
one or more medium voltage switched reluctance traction motors each directly connected to a direct-current (DC) voltage level between 1,000 volts and 6,000 volts and operating at the DC voltage level to provide driving power to the at least one traction device;

2. The work machine according to claim 1, further including:
at least one axle coupled between the medium voltage switched reluctance motors and the traction device to transfer driving power from the motors to the traction device; and
a power source for providing electrical power to the medium voltage switched reluctance traction motors.

3. The work machine according to claim 2, further including:
a chassis,
wherein the at least one axle is associated with two medium voltage switched reluctance traction motors mounted on the chassis in a back-to-back mounting configuration.

4. The work machine according to claim 2, wherein each of the one or more medium voltage switched reluctance traction motors generates between 400 and 600 horsepower.

5. The work machine according to claim 2, wherein each of the one or more medium voltage switched reluctance traction motors generates more than 600 horsepower.

6. The work machine according to claim 2, wherein each of the one or more medium voltage switched reluctance traction motors includes approximately six inches of end turns.

7. The work machine according to claim 2, wherein each of the one or more medium voltage switched reluctance traction motors includes 12 to 18 electrical coils.

8. The work machine according to claim 2, wherein the power source is a fuel cell generator.

9. The work machine according to claim 2, wherein the power source is a diesel engine.

10. The work machine according to claim 2, further including:
a controller configured to control the one or more medium voltage switched reluctance traction motors and the power source.

11. A medium voltage switched reluctance traction motor for use on a work machine, comprising:
a stator inside the medium voltage switched reluctance traction motor with 12 to 18 salient poles;
12 to 18 electrical coils respectively wound on the 12 to 18 salient poles of the stator;
a rotor with a plurality of poles; and
a power converter configured to directly supply a direct-current (DC) voltage of between 1,000 and 6,000 volts to the electrical coils for operating the medium voltage switched reluctance traction motor.

12. The motor according to claim 11, wherein the electrical coils are connected together by about six inches of end turns.

13. The work machine according to claim 11, wherein the electrical coils are configured to operate between 1,000 and 6,000 volts and to generate between 400 and 600 horsepower.

14. The work machine according to claim 11, wherein the electrical coils are configured to operate between 1,000 and 6,000 volts and to generate more than 600 horsepower.

15-20. (canceled)
